(19) United States
(12) Patent Application Publication
(10) Pub. No.: US 2014/0331865 A1
(43) Pub. Date: Nov. 13, 2014

(54) TEA POT

(71) Applicant: Victory Marketing Corp., Keelung City (TW)

(72) Inventor: Tien-Chang HSU, Keelung City (TW)

(73) Assignee: Victory Marketing Corp., Keelung City (TW)

(21) Appl. No.: 14/266,590

(22) Filed: Apr. 30, 2014

(30) Foreign Application Priority Data
May 7, 2013 (TW) 102208428

(51) Int. Cl. A47J 31/06

(52) U.S. Cl. CPC A47J 31/0615
USPC 99/283

(57) ABSTRACT

A tea pot includes a first chamber having a first entrance for access into a first reception space for receiving liquid tea and an outlet opposite to the first entrance; a sieve disposed in the first reception space in order to shield the outlet of the first chamber; a valve unit including a counter, a valve structure electrically coupled with the counter and a valve body, wherein the counter and the valve structure are mounted within the valve body, the valve structure having a valve opening aligned with the outlet; a second chamber coupled to the first chamber via the valve body, the second chamber defining a second reception space and having a second entrance coupled spatially to the valve body. The counter is adapted to activate the valve structure to move between a closed position and an open position.

### CROSS-REFERENCES TO RELATED APPLICATIONS

This application claims the priority of Taiwanese patent application No. 102208428, filed on May 7, 2013, which is incorporated herewith by reference.

### BACKGROUND OF THE INVENTION

1. Field of the Invention

The present invention relates generally to a tea pot, and more particularly to a tea pot, in which a time can be set up in advance such that upon reaching the preset time, tea liquid within a first chamber will flow into a second chamber of the tea pot.

2. The Prior Arts

A conventional tea pot generally defines a reception space for receiving hot water and tea leaves so as to form tea liquid. In order to prevent the tea liquid from turning bitter, a timer is required to remind the drinker to remove the tea leaves or separate the tea liquid from the tea leaves. Hence, this causes inconvenience to the drinker. In addition, tea leaves of different kinds require different immersing time intervals for providing the proper tastes. If the drinker forgets to separate the tea leaves and the tea liquid in an appropriate time, the tea liquid generally turns bitter. Even if a timer is used to remind the drinker, manually labor is still required to separate the tea liquid from the tea leaves, such as pouring the tea liquid out from the tea pot so as to separate the tea liquid from the tea leaves. This causes inconvenience to the drinker.

### SUMMARY OF THE INVENTION

A primary objective of the present invention is to provide a tea pot, in which a time can be set up in advance such that upon reaching the preset time, tea liquid within a first chamber will flow automatically into a second chamber of the tea pot, thereby facilitating the drinker or user and simultaneously preventing the tea liquid from turning bitter.

A tea pot of the present invention accordingly includes a first chamber, a second chamber and a valve unit. The first chamber is used for receiving tea leaves which forms tea liquid when hot water is poured therein. The valve unit is disposed between the first and second chambers. The valve unit includes a counter and a valve opening when the counter reaches a preset time interval, the counter will automatically activate the valve unit between an open position, where the tea liquid within the first chamber will flow into the second chamber, and a closed position, where the tea liquid within the first chamber are prevented from flowing into the second chamber, thereby facilitating the user of the tea pot of the present invention.

A tea pot of the present invention accordingly includes a first chamber having a first entrance for access into a first reception space which receives tea liquid therein and an outlet opposite to the first entrance; a sieve disposed in the first reception space in order to shield the outlet of the first chamber; a valve unit including a counter, a valve structure electrically coupled with the counter and a valve body, wherein the counter and the valve structure are mounted within the valve body, the valve structure having a valve opening aligned with the outlet in the first chamber; a second chamber coupled to the first chamber via the valve body, the second chamber defining a second reception space and having a second entrance coupled spatially to the valve body. The counter is adapted to activate the valve structure to move between a closed position and an open position.

In one embodiment of the present invention, the valve structure further includes a power source, a solenoid coupled electrically with the power source and disposed at one side of the valve opening and a metal ball disposed adjacent to the valve opening in such a manner that when the valve structure is in the closed position, the metal ball blocks the outlet so as to prevent flow of tea liquid from the first chamber into the second chamber, when the valve structure is at the open position, the counter is capable of activating the solenoid so as to cause electromagnetic force attracting the metal ball so as to open the outlet, thereby permitting spatially communication between the first and second chamber and allowing flow of tea liquid into the second chamber from the first chamber.

In addition, the tea pot according to the present invention further includes a lid for covering hermetically the first entrance of the first chamber.

In one embodiment of the present invention, the sieve includes a sieve plate formed with a plurality filtering pores. Preferably, the sieve is semi circle in cross section. More preferably, the valve body is formed with an inner groove for receiving the first chamber partially therein. The tea pot of the present invention further includes a handgrip unit formed at an exterior of the second chamber.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view of the preferred embodiment of a tea pot of the present invention;

FIG. 2 is a cross sectional view of a valve unit employed in the tea pot of the present invention;

FIG. 3 is a cross sectional view of a valve unit employed in the tea pot of the present invention from another angle; and

FIG. 4 is a top planar view of the valve unit employed in the tea pot of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

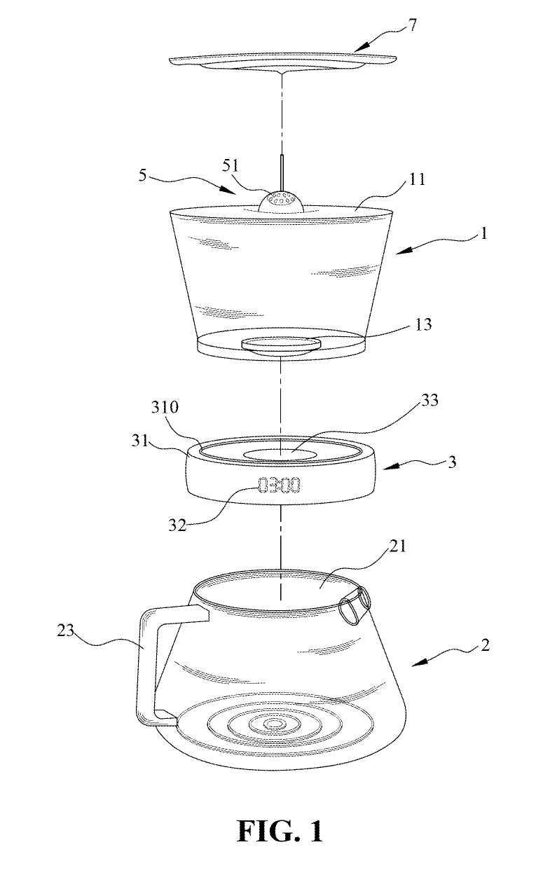

FIG. 1 is an exploded view of the preferred embodiment of a tea pot of the present invention. As shown, the tea pot of the present invention includes a first chamber 1, a second chamber 2, an automatic valve unit 3 and a sieve 5. The first chamber 1 defines a first reception space for receiving liquid tea, has a first entrance 11 for access into the first reception space and an outlet 13 opposite to the first entrance 11. The sieve 5 is disposed in the first reception space in order to shield the outlet 13 of the first chamber 1 so as to prevent tea liquid from flowing through the outlet 13. Preferably, the sieve 5 includes a sieve plate formed with a plurality filtering pores 51. In one embodiment of the present invention, the sieve plate is a semi circle in cross section; however the structure thereof should not be limited only thereto. Other structure that can sieve the tea leaves and only allow flow of the tea liquid can serve as the sieve. The tea pot of the present invention further includes a lid 7 which is configured for covering hermetically the first entrance 11 of the first chamber 1 so as to prevent waste entering into the first reception space.

The valve unit 3 includes a valve body 31, a counter 32 and a valve structure 33 electrically coupled with the counter 32 and the assembly thereof is disposed in the valve body 31. In this embodiment, the valve structure 33 has a valve opening 330 aligned with the outlet 13 of the first chamber 1. Moreover, the counter 32 is adapted to activate the valve structure 33 to move between a closed position and an open position.

As shown in FIG. 1, the valve body 31 is preferably formed with an inner groove 310 for receiving the bottom of the first chamber 1 partially therein. The second chamber 2 is coupled to the first chamber 1 via the valve body 31. The second chamber 2 defines a second reception space, and has a second entrance 21 coupled spatially with the valve body 31 so that the tea liquid within the first chamber 1 can be filtered into the second chamber 2 when the valve structure 33 is at the open position.

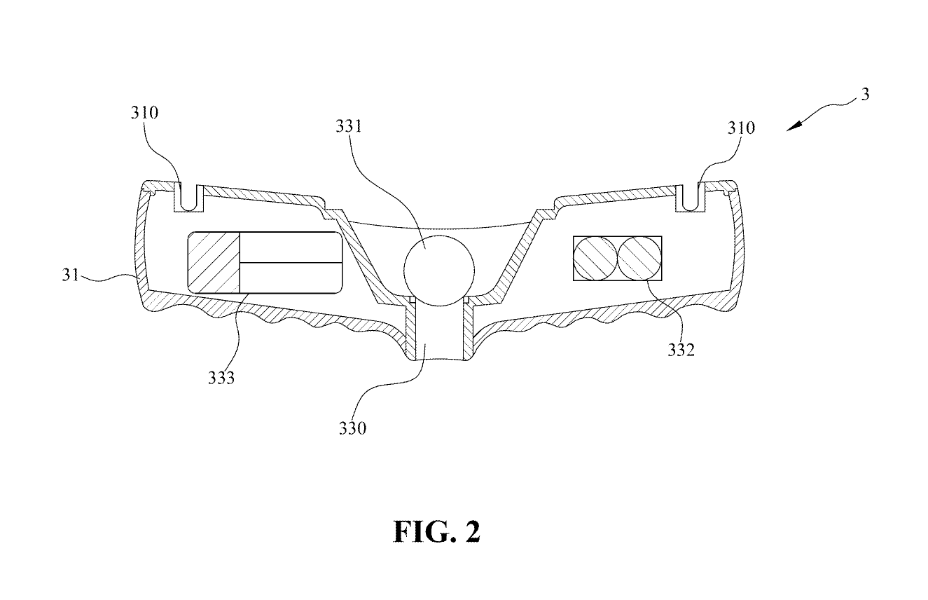

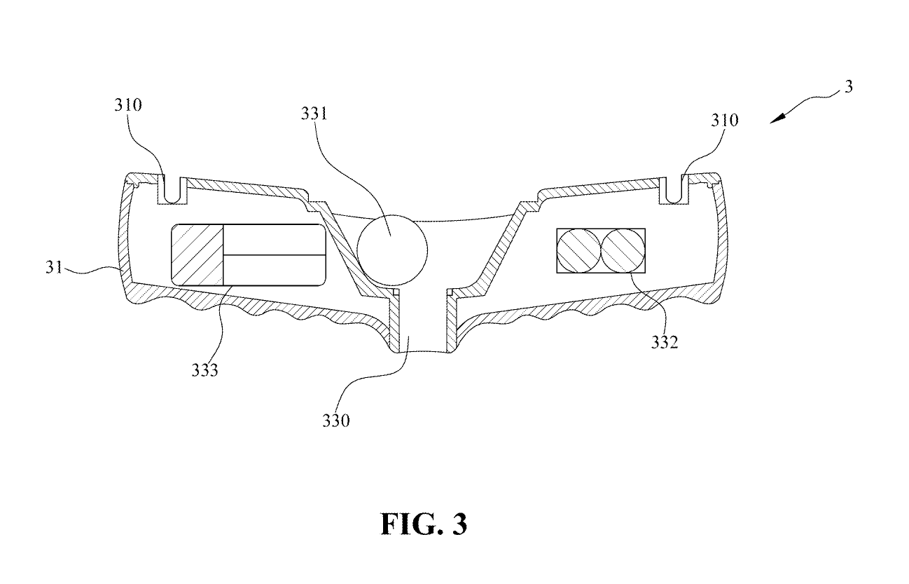

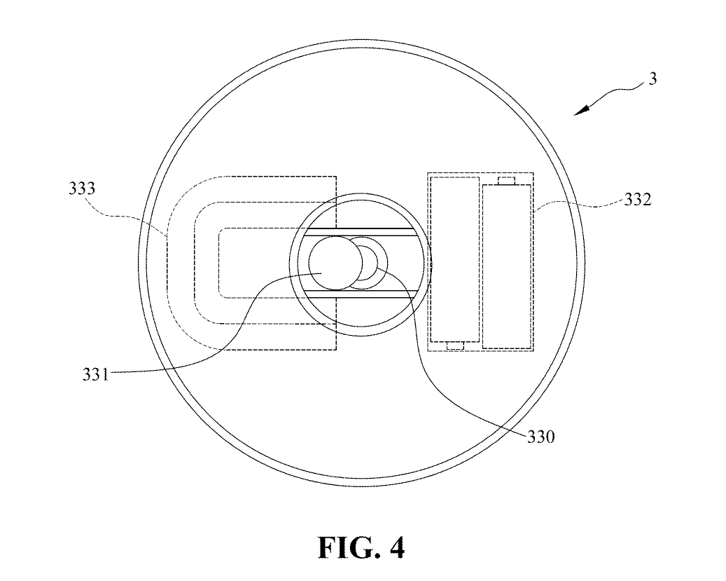

Referring to FIGS. 2 to 4, wherein FIG. 2 is a cross sectional view of the valve unit employed in the tea pot of the present invention; FIG. 3 is a cross sectional view of the valve unit employed in the tea pot of the present invention from another angle; and FIG. 4 is a top planar view of the valve unit employed in the tea pot of the present invention. As shown, the valve structure 33 further includes a power source 332, a solenoid 333 coupled electrically with the power source 332 and disposed at one side of the valve opening 330 and a metal ball 331 disposed adjacent to the valve opening 330. In this embodiment, dry battery can serve as the power source.

At the normal condition, the valve structure 33 is at the closed position, that is the metal ball 331 blocks the valve opening 330 owing to the ground gravity thereof so as to prevent flow of the tea liquid from the first chamber 1 into the second chamber 2, as best shown in FIG. 2. As the tea liquid becomes concentrated or bitter as time past by, the counter 32 is capable of activating the solenoid 33 upon reaching a preset time interval so as to cause electromagnetic force attracting the metal ball 331 (when the valve structure is at the open position) so as to permit spatial communication between the valve opening 330 and the outlet 13, thereby permitting the tea liquid to flow from the first chamber 1 into the second chamber 2, as best shown in FIGS. 3 and 4.

The tea pot of the present invention further includes a handgrip unit 23 formed at an exterior of the second chamber 2 to facilitate handling of the tea pot.

It is to note that no manual labor is required and the tea liquid will automatically flow into the second chamber 2 from the first chamber 1 owing to the specific structure of the valve unit 3.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A tea pot comprising:
a first chamber defining a first reception space for receiving liquid tea, having a first entrance for access into said first reception space and an outlet opposite to said first entrance;
a sieve disposed in said first reception space in order to shield said outlet of said first chamber;
an automatic valve unit including a counter, a valve structure electrically coupled with said counter and a valve body, wherein said counter and said valve structure are mounted within said valve body, said valve structure having a valve opening aligned with said outlet of said first chamber;
a second chamber coupled to said first chamber via said valve body, said second chamber defining a second reception space and having a second entrance coupled spatially to said valve body;
wherein said counter is adapted to activate said valve structure to move between a closed position and an open position.

2. The tea pot according to claim 1, wherein said valve structure further includes a power source, a solenoid coupled electrically with said power source and disposed at one side of said valve opening and a metal ball disposed adjacent to said valve opening in such a manner that when said valve structure is in said closed position, said metal ball blocks said outlet so as to prevent flow of tea liquid from said first chamber into said second chamber, when said valve structure is at said open position, said counter being capable of activating said solenoid so as to cause electromagnetic force attracting said metal ball so as to open said outlet, thereby permitting spatially communication between said first and second chamber.

3. The tea pot according to claim 1, further comprising a lid for covering hermetically said first entrance of said first chamber.

4. The tea pot according to claim 1, wherein said sieve includes a sieve plate formed with a plurality filtering pores.

5. The tea pot according to claim 1, wherein said sieve is semi circle in cross section.

6. The tea pot according to claim 1, wherein said valve body is formed with an inner groove for receiving said first chamber partially therein.

7. The tea pot according to claim 1, further comprising a handgrip unit formed at an exterior of said second chamber.
